(19) United States
(12) Patent Application Publication
(10) Pub. No.: US 2015/0289047 A1
(43) Pub. Date: Oct. 8, 2015

(54) HEADPHONE

(71) Applicant: Phitek Systems Limited, Newmarket (NZ)

(72) Inventor: NIGEL GREIG, Pt. Chevalier (NZ)

(21) Appl. No.: 14/680,627

(22) Filed: Apr. 7, 2015

(30) Foreign Application Priority Data
Apr. 7, 2014 (NZ) 623225

(51) Int. Cl. H04R 1/10

(52) U.S. Cl. CPC H04R 1/105

(57) ABSTRACT

Various systems, processes, and techniques may be used to provide a headphone apparatus. In certain implementations, a headphone apparatus may include a headband and an earpiece that is supported by the headband. The headband may include two resilient conductive elements that are separated by an insulator. The conductive elements may provide a conductive path for an electrical signal or supply to the earpiece.

### FIELD OF THE INVENTION

This invention relates to headphones and similar devices which have one or more earpieces and a headband which supports the earpieces on a user's head.

### BACKGROUND

Headphone apparatus itself is well known, comprising three general components, a headband and two earpieces. Although the present disclosure primarily describes embodiments having two earpieces, single earpiece embodiments could be provided. Also, the apparatus may additionally include a microphone. Similarly, although the description in this document refers to embodiments which are effectively super aural headphones, embodiments which are circumaural, or in the ear headphones could also be provided. Similarly, embodiments in which the structure is used to provide ear muffs or ear warmers are also possibilities within the scope of the present disclosure.

Although many headphone products are designed for “high end” uses such as HI fidelity listening experiences, active noise reduction etc., there is a need for inexpensive headphones. This need is apparent in some industries such as the airline industry for example where headphones are frequently used by passengers for inflight entertainment.

Although some passengers are happy to pay for enhanced entertainment experiences, there is a significant market for low cost fares and corresponding low cost entertainment solutions. In particular, in an airline environment headphones can frequently be damaged or lost so it is also highly desirable to not only provide an inexpensive headphone product, but one which is also relatively simple and robust. Moreover, the solution should be easily repairable or replaceable so as to minimize the cost associated with replacing headphones or headphone parts.

A further difficulty is that efficient storage of headphones or headphone components is also important in the airline industry. When headphones are not in use they need to be capable of being stored efficiently and compactly i.e. with a minimum spatial requirement.

### SUMMARY

It is an object to the present invention to provide an improved headphone apparatus, or to at least provide headphone apparatus which will provide a useful alternative to existing constructions.

In one aspect, this disclosure broadly provides a headphone apparatus that includes a headband and an earpiece supported by the headband, wherein the headband includes two resilient conductive elements separated by an insulator, the conductive elements providing a conductive path for an electrical signal or supply to the earpiece.

In some embodiments, the earpiece is supra aural, and in other embodiments, the earpiece may be circumaural. In some embodiments, the earpiece may be partially or fully located inside the ear or ear canal.

The insulator may include one or more pieces of insulating material which separates the resilient conductor elements.

In some embodiments, the insulator maintains the conductive elements in position relative to each other.

In certain embodiments, the resilient conductor elements are constructed from a spring-like conductive material such as spring steel. In particular embodiments, the earpiece is slideably adjustable along the headband so as to enable the earpiece to be positioned selectively for listening in comfort by the user.

The earpiece may have one or more sliding contacts which make electrical contact with the conductive elements of the headband to thereby pass electrical power or signals to the earpiece. The electrical signals include audio frequency electrical signals (audio signals).

In some embodiments, the earpiece(s) are slideably moveable along the headband to adjust the position of the earpiece.

In particular embodiments, the earpiece(s) can be slideably removed from the headband. Preferably, the earpiece or another earpiece can be slid onto the headband.

In certain embodiments, one earpiece receives an audio signal and passes the audio signal to the other earpiece via the headband.

In some embodiments, one earpiece is connected to an audio cable to receive audio signals.

In particular embodiments, an input audio signal which may include a two channel signal is provided to one earpiece such that at least one channel is received by the first earpiece, and the second channel is provided to the conductive elements for receipt by a second earpiece at the other end of the headband.

Two additional channels may be used to pass noise cancellation (anti-noise) signals to the seat arm where active noise cancellation electronics or support is provided.

In certain embodiments, the headband is contoured those to enable the earpiece or earpieces to be selectively disposed in a storage orientation. The headband may include a contour to enable the earpiece(s) to be slid from an operative or listening orientation to the storage orientation. The earpiece(s) may also be slid from the storage orientation to the operative orientation.

In another aspect, the disclosure broadly provides a headband for a headphone apparatus, the headband including two resilient conductive elements separated by an insulator, the conductive elements providing conductive path for an electrical signal or electrical supply for an earpiece which may be optionally mounted on the headband.

In some embodiments, additional resilient conductive elements, or conductive elements, may be used to pass additional signals such as a noise cancellation signal (anti-noise) from one earpiece to the other so that noise cancellation can be provided for in the seat.

In yet a further aspect, the disclosure broadly provides an earpiece for a headphone having electrical contacts which provide electrical sliding contact with a headband of the headphone to receive an electrical signal or supply therefrom.

In some embodiments, the electrical sliding contact can provide an electrical supply or signal to another earpiece on the headband.

In particular embodiments, the earpiece includes a cap which captures the conductive elements between the cap and a housing of the earpiece. The cap may be biased against the housing to retain the earpiece in connection with the conductive elements while allowing sliding movement therebetween.

A detent means may also be provided to facilitate adjustable sliding movement between the headband and the earpiece.

In yet another aspect, the disclosure broadly provides a headphone headband, the headband being contoured to allow one or more earpieces slideably mounted on the headband to translate relative to the headband from a listening orientation to a storage orientation.

In certain embodiments, the headband is contoured such that an earpiece may be translated through about 90° from the listening orientation to the storage orientation. In the storage orientation, the earpieces may be disposed and substantially in the same plane. In the listening orientation, the earpieces may be disposed substantially opposite to each other in separate planes.

In one aspect, the invention may be broadly consist in a headphone that includes:
a central support region for supporting the headphones in use;
a plurality of resilient elements extending from the central support region; and
at least one earpiece connected to the resilient elements,
wherein the earpiece may be rotated relative to the central support region by rotation of the resilient elements.

In another aspect, the invention may broadly consist in a headphone that includes:
a central support region for supporting headphones in use;
a plurality of resilient elements extending from the central support region; and
at least one earpiece connected to the resilient elements,
wherein the resilient elements are, or can be, positioned with a contoured such that the earpieces can be translated into a storage position.

In an additional aspect, the invention may broadly consist in a headphone that includes:
a central support region for supporting headphones in use;
a plurality of resilient elements extending from the central support region; and
at least one earpiece connected to the resilient elements,
wherein the resilient elements are, or can be, positioned with a contour so that the earpieces can be translated into a storage position.

In some embodiments, the resilient elements have a fixed contour.

In particular embodiments, the resilient elements rotate or twist so that the contour of the resilient elements changes.

In certain embodiments, the resilient elements are conductive and conduct power or signal to the at least one earpiece.

In some embodiments, there are two earpieces.

In yet another aspect, the invention may broadly consist in a headphone comprising:
a central support region for supporting headphones in use;
a plurality of resilient elements extending from the central support region; and
at least one earpiece with a front face, the earpiece connected to the resilient elements,
wherein the at least one earpiece is adapted to be positioned in:
a first position in which the front face is directed towards the ears of a user wearing the headphone; and
a second position in which the earpiece is directed away from the ears of a user.

In some embodiments, the earpiece is directed substantially 90 degrees away from the ears of a user in the second position.

In particular embodiments, the first position is an in-use position and the second position is a storage position.

In certain embodiments, the headphones are slidably connected to the resilient elements.

In some embodiments, the resilient elements extend through the central support region.

In certain embodiments, there are two resilient elements, each pair of resilient elements supporting an earpiece on each side of the central support region.

Further aspects of the inventive concepts will become apparent from the following description.

### DRAWING DESCRIPTION

One or more embodiments will now be described with reference to the drawings.

FIG. 1 is a side elevation of an example headphone.

FIG. 2 is a front elevation of the headphone shown in FIG. 1.

FIG. 3 is an isometric partial view of an example earpiece for the headphone of the preceding Figures.

FIG. 4 is a front elevation of the headband for the headphone of the preceding Figures without the earpieces.

FIG. 5 is a front elevation of the headphone shown in the preceding Figures with one earpiece in an operative orientation and another earpiece in a storage orientation.

FIG. 6 is an elevation in cross-section of an earpiece for the headphone of the preceding Figures.

FIG. 7 is an exploded view of an embodiment of an earpiece.

FIG. 8 is an isometric view of a second example headphone.

FIG. 9 is an isometric view of the embodiment of the headphones shown in FIG. 8 with the earpieces in a rotated position.

FIG. 10 is an isometric partial view of the earpiece in connection with the headband.

FIG. 11 is an isometric view of a third example headphone.

FIG. 12 is an exploded view of the headphone of FIG. 11.

### DETAILED DESCRIPTION

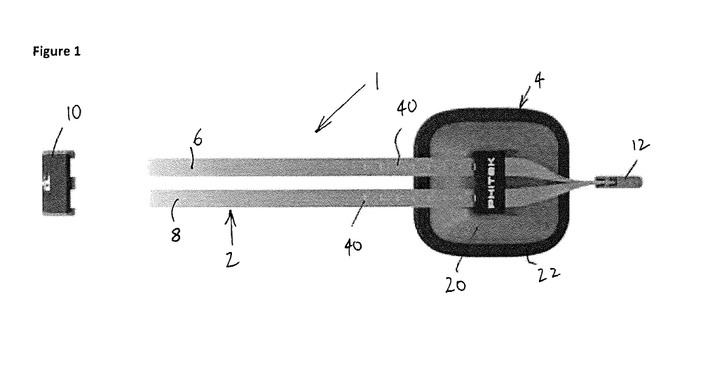

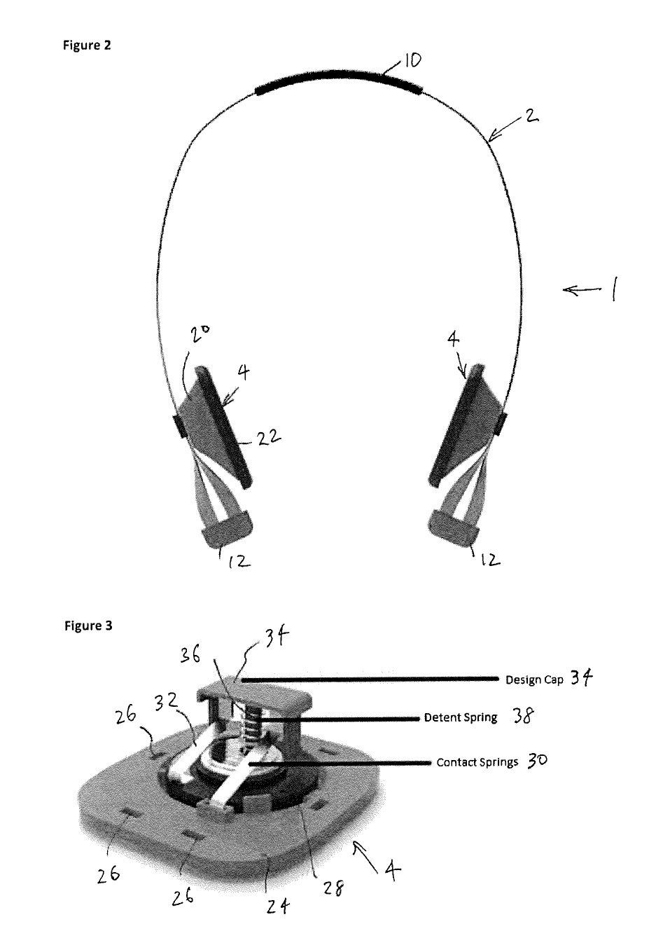

Referring to FIGS. 1 and 2 a headphone, which is generally referenced 1, is shown in side and end elevation respectively. The headphone 1 has a headband 2 and two earpieces 4. Those skilled in the art will appreciate that in some embodiments only a single earpiece 4 may be provided, and that the earpiece(s) may take a variety of different forms such as a circumaural form for example, or comprise in-ear devices.

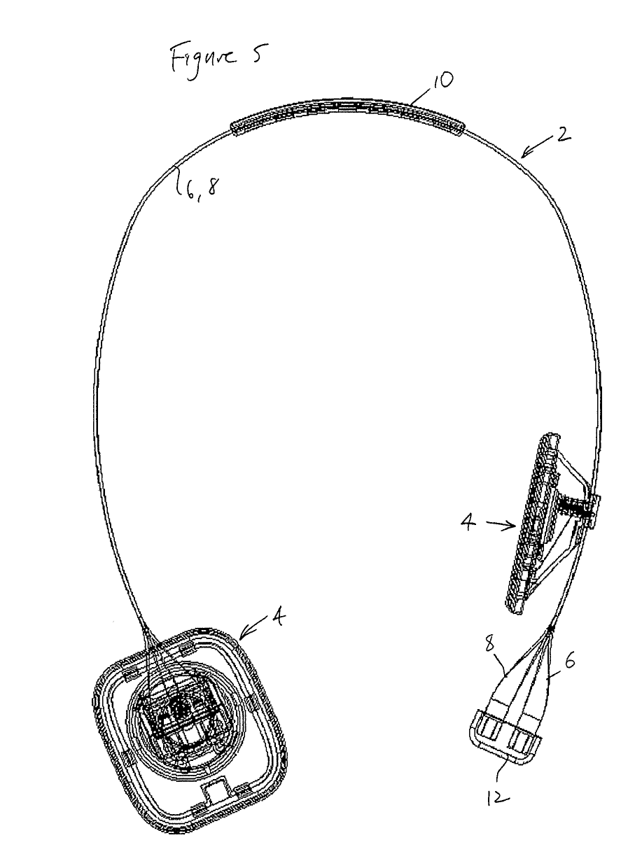

The headband supports the earpieces, and is constructed from a resilient material to enable it to apply a suitable force maintain the earpieces in close association with the ears and/or head of a wearer. The resilient material therefore provides a structure or support for the headband and the earpieces connected to the headband, acting as a skeleton or scaffold for the headpiece. The skeleton may be flexible or malleable to, for instance, allow the headphones to be adjusted for fit. Thus the headband 2 is formed in a curve as shown in the drawings (see FIGS. 1, 2, 4 and 5) in which it is in a resting position off the head. In the resting position shown in the drawings the ends of the headband are nearer to each other than they typically are in use when the headband is being worn by a user.

While this document primarily describes the material from which the headband 2 is formed as being resilient, it will be appreciated that the material may have other properties, for example being de-formable or malleable to a required extent for the intended purpose. In other words, the degree of resilience may be relatively small—for example just sufficient to allow the headphone to hold the earpieces in relatively close proximity to the user's ears while another property such as malleability may allow the headphone to be broadly adjusted to the shape of the user's head.

The headband 2 is not only constructed from a resilient material, but is also conductive. In one embodiment the primary material from which the headband is formed is spring steel. Those skilled in the art will appreciate that other materials may be used. Further materials may be added to the headband, in addition to the resilient material, in order to make the headbands more visually appealing or comfortable.

The conductive nature of the resilient material from which the headband is formed provides a conductive path for electrical signals or an electrical supply to one or both earpieces 4. Two conductors 6, 8 are provided separated by one or more insulating elements. The insulating elements simply ensure that the conductors are sufficiently separated that they do not touch each other in use. A variety of different insulating arrangements may be used, provided only that the earpiece(s) can make electrical contact with the conductors 6, 8 in the end regions of the headband, as will be described further below.

The insulator arrangement in the embodiment shown includes a central support member 10 which supports the central area of each conductor while also maintaining separation between them. The body or housing of each earpiece 4 can also provide a separation/insulator function, and in some embodiments may be all that is required. In the embodiment shown, end pieces 12 can also assist in supporting and/or separating the conductors 6, 8. End pieces 12 may provide a stop to prevent the earpieces from being inadvertently removed from the headband; however, they are also preferably removable to allow the earpieces to be selectively removed for maintenance, repair, or replacement. Multiple insulator sections may be used or the conductors may be partially encapsulated by the insulator.

The headband 2 has a central region around central support 10, and distal end regions 14 in which the headband is contoured to provide a transition from being in a plane substantially parallel to the user's ear or head, to a substantially perpendicular orientation. The result is that an earpiece, when slid along the headband to the distal end region 14, transitions or translates from an in use or listening position in which it is substantially parallel to the user's ear to a storage position is which is substantially perpendicular to the users ear. The transition is substantially 90 degrees, but may be greater or lesser than that depending on the individual headphone design. The storage orientation flattens the end profile of the headphone. Thus, the headphone can be stored more efficiently.

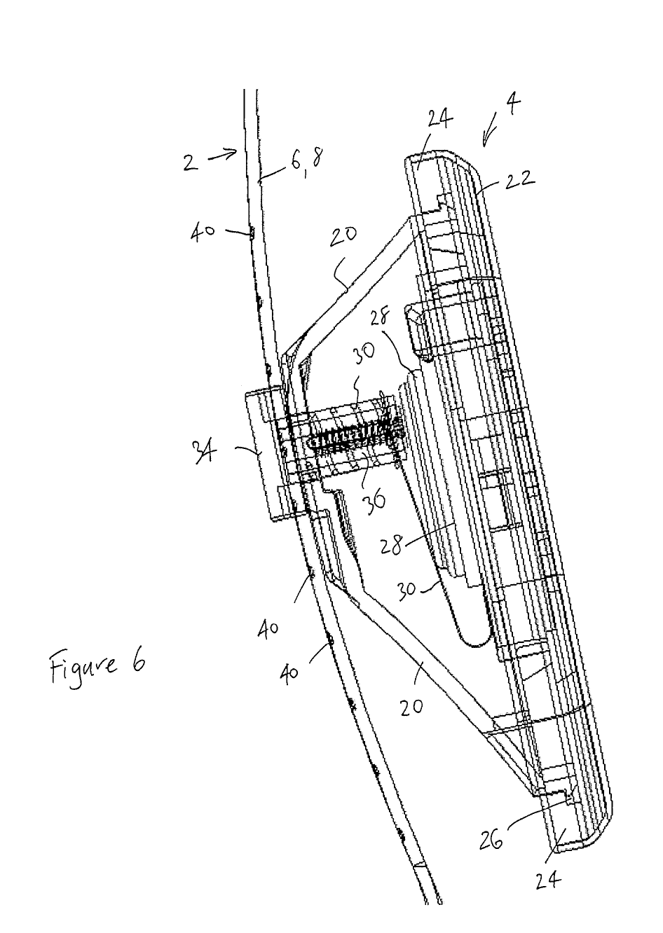

The change in orientation is perhaps best seen with reference to FIG. 5.

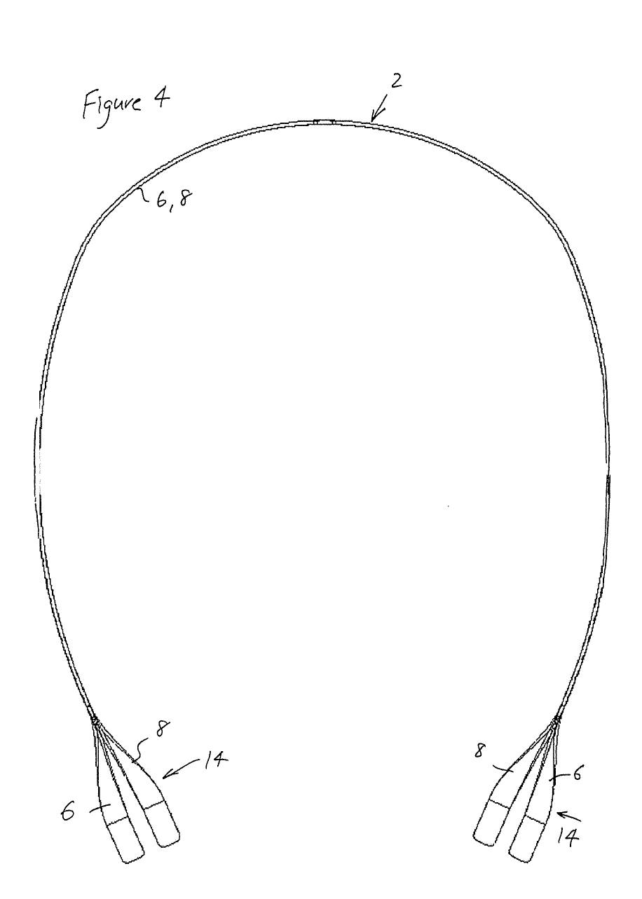

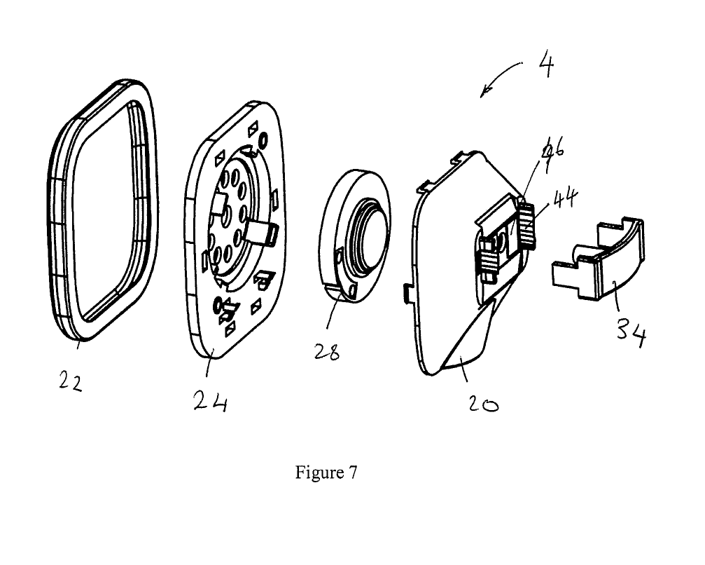

Turning now to FIGS. 3 and 6, the earpiece 4 is shown in greater detail. In FIG. 3 the outer housing 20, and the cushion 22, have been removed. The earpiece has a base 24 with engagement apertures 26 for connecting the housing 20 thereto. The base 24 supports a driver (i.e. speaker) assembly 28 which is electrically connected to sliding sprung contacts 30 and 32. One end of each of contacts 30 and 32 makes electrical contact with the driver 28 (or a conductor associated with the driver) and the other end of each contact protrudes though an aperture on the housing 20 to touch the conductors 6 and 8 respectively. When the earpiece is moved slidably along the headband, the protruding portions of conductors 30 and 32 slide along the conductors 6 and 8, maintaining electrical contact therewith.

A cap 34 having a stem 36 is mounted on the housing 20 so as to be moveable relative to housing 20 in an axial direction along stem 36. The stem 36 supports a biasing member including detent spring 38 which acts to bias the cap 34 toward the housing. In use the conductors 6 and 8 are disposed between the outside of housing 20 and an inner surface of cap 34. An outer surface of one or both conductors 6 and 8 has small recesses 40 thereon (refer FIG. 1). Similar or complementary projections or recesses can be provided on the inner surface of the cap 34. Recesses 40 provide detent recesses, or projections therebetween, so that the arrangement of the biased cap and the recesses 40 includes a detent mechanism that allows adjustment of the position of each earpiece relative to the headband. Furthermore, the biasing of cap 34 toward the housing assists with ensuring that the contacts maintain electrical contact with conductors 6 and 8.

In use, the audio cable that supplies the electrical audio signal to the headphone is connected (for example being soldered) to a first one of the earpieces. Other connections, such as an audio socket being provided on the earpiece to receive a plug connected to an audio cable, are possible alternatives. The second earpiece does not need any cable connections since the audio signal is passed by contacts 30 and 32 of the first earpiece onto the conductors 6 and 8 of the headband 2, and thence to conductors 30 and 32 of the second earpiece so that the electrical connection is made. This arrangement is possible with both a single or dual channel signal. If there are two channels, then the electrical connection arrangement at the first earpiece includes connecting the common or ground line to say conductor 6 via contact 30, connecting the first channel to the driver for the first earpiece, and connecting the second channel to contact 32 for provision to conductor 8.

In other embodiments the headphones may be wireless, with signal reception occurring at one earpiece and the signal for the other earpiece being conveyed via conductors 6 and 8. In yet other embodiments, the conductors 6 and 8 to provide a low voltage low power supply from one earpiece to the other. There may be additional electrical communication means, such as a conductor, wire or wireless communication means in the headband. For instance two additional wires may be used to pass noise cancellation signals between the earpieces, or to an external control means (e.g. by the cable connected to the headphones). These conductors may be resilient to provide additional support to the headband, or may be simple cables. For instance on an aircraft there may be a noise cancellation means contained in the external electronics (i.e. the seat electronics) which may require a microphone input from the headphones. If the cable is connected to only one of the earpieces and a further conductor may be contained in the headband to allow this signal to be returned from the second earpiece.

The embodiments described above provide a number of advantages. The headband is simple, low cost and easy to manufacture. The absence of cable(s) from one earpiece to the other is a cost saving, and reduces potential cable termination and connection problems. The avoidance of complex mechanisms for transitioning the earpieces to a storage mode is also advantageous.

One of the most significant advantages is the ease with which defective earpieces may be replaced. The defective earpiece may be simply slid off the headband (after removing end piece 12), and the replacement unit is then simply slid on as a replacement.

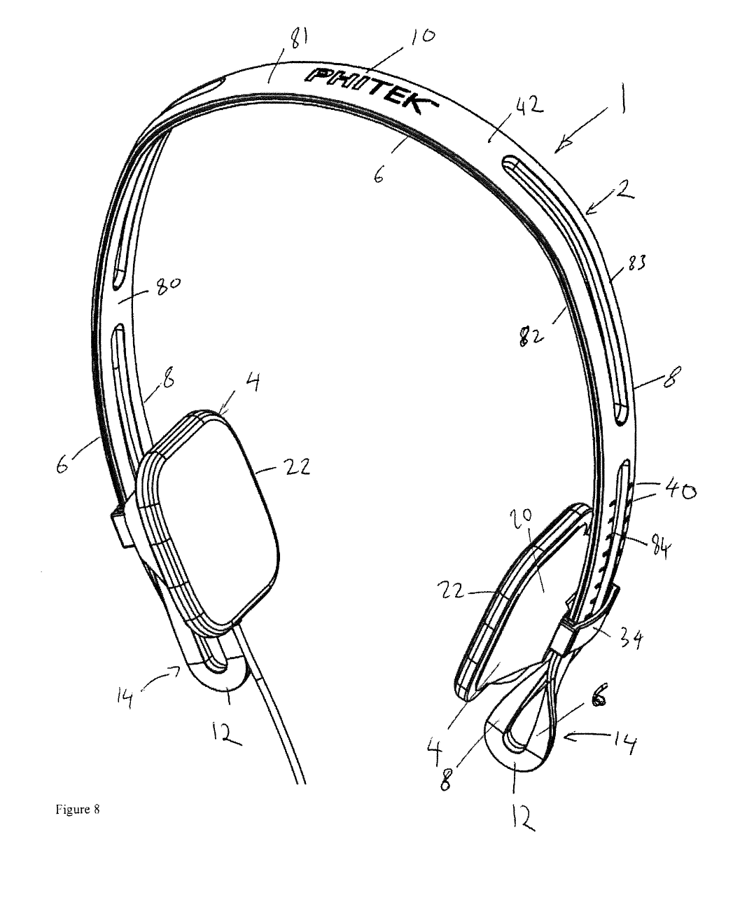

FIG. 7 shows a second embodiment of an earpiece, which is a view similar to that shown in FIG. 3. The cushion 22 is mounted on a base 24 which has engagement apertures and/or protrusions for connection to the cushion 22, driver 28 and housing 20. In the shown embodiment the housing also has engagement apertures and protrusions including for the cap 34. The embodiment does not show the electrical connections (e.g., the contact springs 30,32 of FIG. 3); however, these, or related connection means, would be present as would be the detent spring 38. The cap 34 is biased towards the housing 20 but may be removable, for example for cleaning or repair. Removal may be by removal of the cap or via the ends 12 of the headset 2. The electrical connections may be arranged to run between the housing 20 and the cap 34. Connection may be achieved through contact areas 46, which includes contact springs which are biased to improve contact. The contact areas may also be on protrusions such as 44 and contact the sides or side portions of conductors 6, 8. The simplicity of components in the headset allows simple repair and fewer weak points.

FIG. 8 shows an embodiment of the headphone 1 which includes two earpieces 4 as shown in FIG. 7. In this embodiment the headband 2 has two conductors 6, 8 which are resilient and are encased in a sheath or housing 42. The protective sheath may be made from a non-conductive material such as plastic or another insulator. In particular embodiments, the sheath or housing is protective in that it reduces contact with the conductors and allows the appearance of the headband 2 to be configured. The embodiment shows the conductors 6 and 8 having a side surface which extends beyond the housing 42 along the length of the headband 42. In the shown embodiment the conductors protrude from the sides 82, 83 of the headband 42 however in alternative arrangements they may protrude from the inner 80 or outer 81 surface of the headband or a combination of these. In a further alternative they may be affixed to a surface of the headband. In alternative embodiments a portion of this may be covered, such as at the central support member 10. The resilience of the headband may be, completely or in part, provided by the housing 42 in some embodiments.

FIG. 8 shows the earpieces 4 connected to the headband 2 through an aperture between the cap 34 and the housing 20. The stem or protrusion 36 extends through an aperture 84 of the headband. The stem 36 and aperture 84 is not required for all embodiments but allows the movement of the earpiece to be restricted and/or controlled as well as providing additional support. For instance the earpiece could be mounted by a the inner surface of the cap 34 being biased towards the housing 20 by biasing means such as springs inside the earpiece 4. A number of recesses or protrusions 40 provide a detent mechanism to allow adjustment of the earpiece although other adjustment means such as thumb screws are known in the art. The distal end 14 of the headband is contoured to provide the effect described with respect to FIG. 2 in which the orientation of the earpieces is adjustable by translation or sliding along the headband. In an embodiment this portion, or selected portions, of the headband may be made less malleable (e.g. by increasing the thickness of the conductors or plastic) to maintain a desired contour. End caps 12 may be present and may be removable to make removal of the earpieces straightforward.

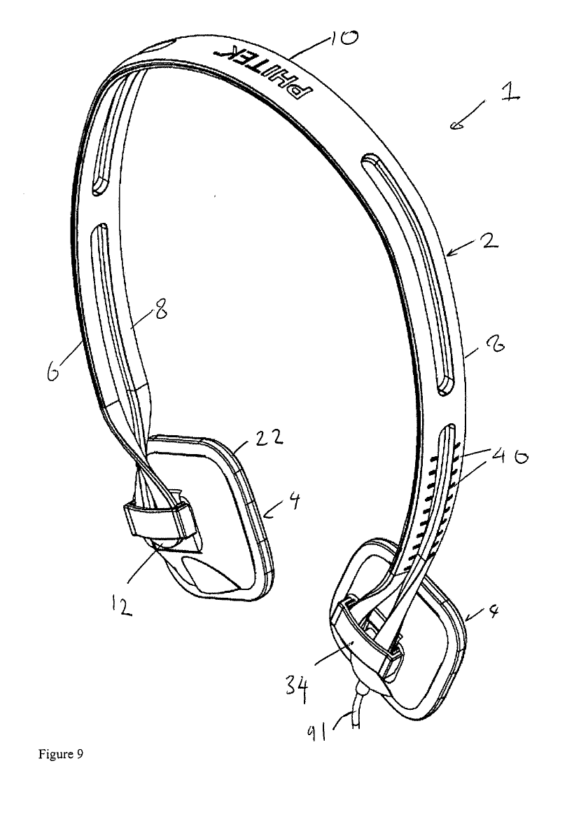

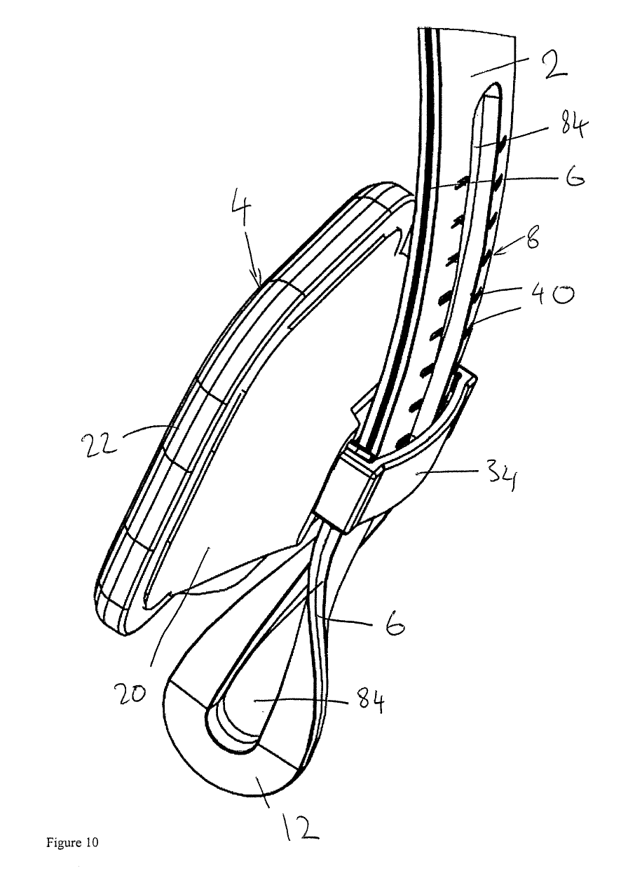

FIG. 9 shows the headphone 1 in the storage position with the earpieces 4 positioned at the distal end of the headband 2. The headband contour has caused the earpieces to rotate so as to be approximately 90 degrees from the in use position as they are translated to the distal end of the headbands. In different embodiments this rotation may be more or less, depending on the best position for ergonomic wear and for storage, the earpieces simply follow the angle of the headband. For example, the headphones may rotate between 45and 135 degrees, although rotation outside of these bounds may also be appropriate. Preferably, the rotation is at the distal end so that the headband 2, including the central area 10 provides a comfortable support surface for a user. FIG. 9 shows a cable 91 providing an electrical connection to one of the earpieces. In particular embodiments, this is the only electrical connection to the headphones, with power and signal supplied to the other earpiece by conductors 6, 8.

FIG. 10 is a magnified view of the earpiece connected to the headband 2. The connection to the conductor 6 is shown, where the conductor 6 may be protruding, or a conductive protrusion from the cap 34 may be used, to contact a conductor in a recess of the headband 2. To ensure easy return to the storage position there may be a means of releasing or reducing the connection (not shown) between the earpiece 4 and the headset 2 so that the earpieces may slide under their own weight or with limited force to the distal end 14 under gravity when held in the vertical position. As in the earlier embodiments there may be less insulator material present exposing more of the conductive material.

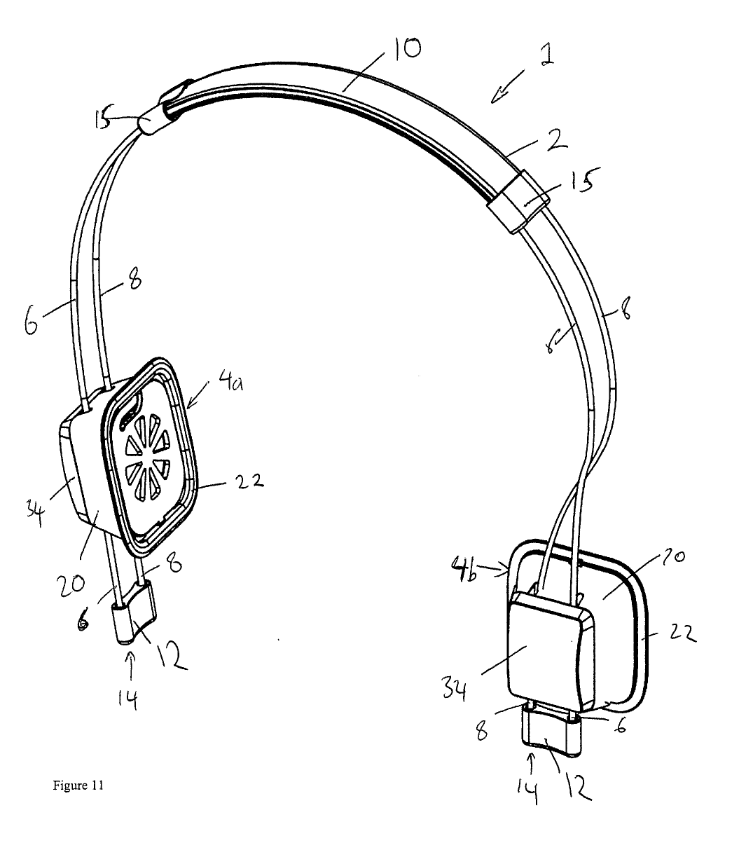

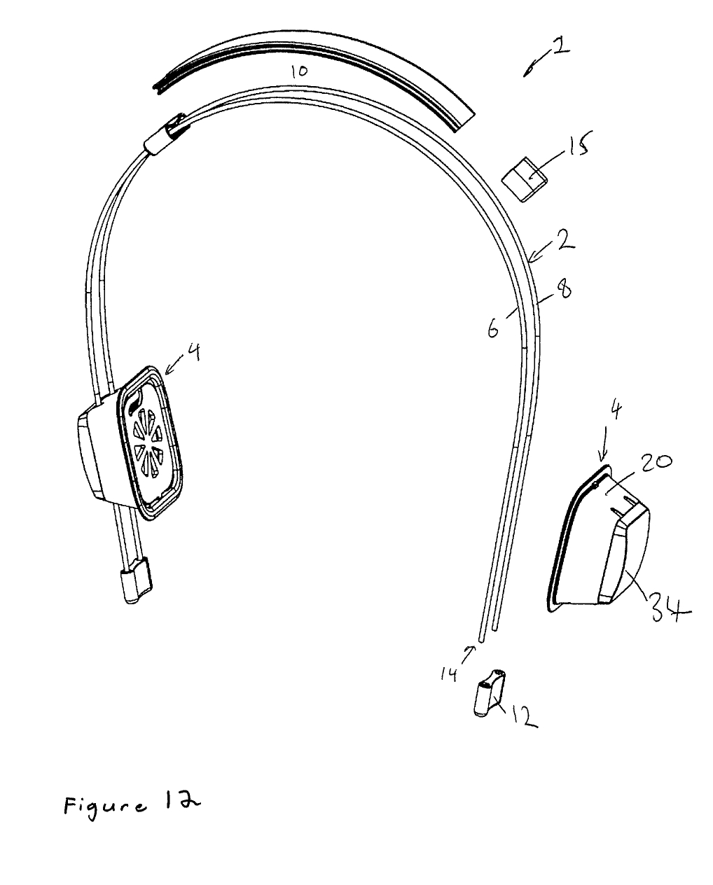

FIG. 11 shows an embodiment of the headphones 1 where the rotation of the earpieces 4 for storage is achieved an adjustable contour of the headphones. The headband has a central support 10 with ends 15. The ends 15 provide a means of maintaining the space between the conductors 6, 8 and a fixed position for those conductors. A fixed position means that there is substantially no relative movement and/or rotation of the conductors 6, 8 at the ends 15. The conductors 6, 8 are then substantially freely suspended from the end 15 of the central support to the distal end 14 of the headband. Although in other embodiments there may be insulator material maintaining a separation between them. The conductors are made of a resilient material such as a metal wire or flat cable that allows a rotation of the conductors to occur. The conductors 6,8 may be partially surrounded by an insulator material for visual appearance or support either individually or suitably connected. A relative rotative force between the central support 10 and an earpiece 4 encourages a rotation of the conductive supports 6, 8. As the supports are free to rotate different amounts, the earpiece can be rotated to a storage position 4b, for instance substantially 90 degrees, from the in use position 4a. The rotation may occur after an earpiece has been positioned at the distal end of the headband.

This rotation is an outcome of the two connections having a portion of their length along which they are not directly connected so that a rotation of a first of them does not require the same rotation of the second. This rotation therefore creates a contour in the headband, along which the earpieces can be translated. In particular uses, the earpieces would be slid to the distal end 14 of the headband 2 before being rotated, however they may also be rotatable in position. The rotation shown in FIG. 11 has been exaggerated for easy viewing, in a typical situation the rotation would be along the whole length of the conductors 6, 8.

Although the rotation means has been described in conjunction with the use of two resilient conductors it the rotation means would similarly function with any design having earpieces suspended on two supports which are able to rotate relative to one another. For example in another embodiment these may be support struts and a separate electrical connection may be made, or the electrical connection may pass through the centre of a support strut. The conductors 6, 8 may be resilient and biased slightly inwards so as to maintain enough pressure on a user's head to hold in place when in use. The resilient members have been shown as circular, however in other embodiments they may form ribbons or other shapes provided that they have the ability to rotate or twist.

The earpieces 4a, 4b are connected to conductors with a physical and electrical connection. The embodiment shows the conductors passing between the housing 20 and the cap 34 of the earpieces however alternative embodiments are possible. A detent mechanism may be used to ensure good contact and/or connection between the earpiece and the conductors. The connection should be slidable to allow a user to position the earpieces at a desired height. To improve the security of the earpiece positioning a detent mechanism or series of protrusions may be placed on or around the conductors. The conductors may have a housing or plastic surround to add to their appearance or resilience. Alternatively the earpieces may use a connection as described with reference to the other embodiments.

FIG. 12 shows an exploded view of the headphones 1 of FIG. 11. One of the earpieces 4 is shown as disconnected from the headset, this may be useful for repair or adjustment. Removal may occur by removing the end cap 12 from the distal end 14 of the headband and sliding the earpiece along the conductors. The figure shows the conductors continuing from one earpiece to the second earpiece so as to be able to provide electrical power and signals to the second earpiece. An external cable or electrical connection (e.g. wired or wireless) will normally be supplied to only one of the earpieces.

As mentioned earlier in this document, the disclosure is applicable to a variety of different embodiments and should not be read as being limited to the embodiments and application specifically described herein. For example, in some instances only one earpiece may be provided. Also, although the description in this document refers to embodiments which are effectively super aural headphones, embodiments which are circumaural, or in the ear headphones could also be provided. Similarly, embodiments in which the structure is used to provide ear muffs or ear warmers are also possibilities within the scope of the present disclosure.

What we claim is:

1. A headphone apparatus comprising:
a headband; and
an earpiece supported by the headband,
wherein the headband comprises two resilient conductive elements separated by an insulator, the conductive elements providing a conductive path for an electrical signal or supply to the earpiece.

2. A headphone as claimed in claim 1 wherein the earpiece is slideably adjustable along at least a portion of the headband to enable the earpiece to be positioned selectively.

3. A headphone as claimed claim 1 wherein the earpiece has one or more sliding contacts which make an electrical connection with the conductive elements of the headband, wherein the electrical connection may be used to pass electrical power or signals to the earpiece.

4. A headphone as claimed claim 1 wherein the earpiece can be slideably removed from and/or inserted onto the headband.

5. A headphone as claimed claim 1 wherein there are two earpieces.

6. A headphone as claimed in claim 5 wherein a first earpiece receives an audio signal and passes the audio signal to a second earpiece via the headband.

7. A headphone as claimed in claim 6 wherein the first earpiece is connected to an audio cable to receive audio signals.

8. A headphone as claimed claim 6 wherein the audio signal has a plurality of channels and the first earpiece receives at least one channel and the second earpiece receives a second channel.

9. A headphone as claimed claim 6 comprising an electrical conductor to pass signals from the second earpiece to the first earpiece.

10. A headphone as claimed claim 6 wherein the headband is contoured, or can be contoured, to enable the direction of the earpiece to be selectively adjusted.

11. A headphone as claimed in claim 10 wherein the direction of the earpiece may be adjusted between a listening position and a storage position.

12. A headphone as claimed in claim 10 wherein the earpiece may be selectively adjusted by sliding the earpiece along the headband.

13. A headphone as claimed in claim 10 wherein the earpiece may be selectively adjusted by rotation of the resilient conductive members.

14. A headphone as claimed in claim 1 wherein the earpiece comprises a cap which creates an aperture for the headband of the headphone between the cap and a housing of the earpiece.

15. A headphone as claimed in claim 1 wherein the earpiece and/or headband comprise detent means to facilitate adjustable sliding movement between the headband and the earpiece.

16. A headband contoured, or able to be contoured, so that one or more earpieces slidably mounted on the headband, can be selectively adjusted between an in use position and a storage position.

17. A headphone comprising:
a headband comprising resilient elements extending from a central support region; and
an earpiece supported by the headband;
wherein the resilient elements are, or can be, contoured so that the earpieces can be selectively adjusted between an in use position and a storage position.

18. A headphone as claimed in claim 17 wherein the resilient elements rotate or twist so that the contour of the resilient elements is adjustable.

19. A headphone as claimed in claim 17 wherein the resilient elements are conductive and conduct electrical power or electrical signal to at least one earpiece.

20. A headphone as claimed in claim 17 comprising two resilient elements on each side of the central support region, the resilient elements supporting an earpiece on each side of the central support region.
